(19) United States
(12) Patent Application Publication
(10) Pub. No.: US 2020/0074974 A1
(43) Pub. Date: Mar. 5, 2020

(54) Acoustically Transparent Loudspeaker-Sensor System

(71) Applicants: Matthew T. Neal, State College, PA (US); Thomas E. Blanford, State College, PA (US)

(72) Inventors: Matthew T. Neal, State College, PA (US); Thomas E. Blanford, State College, PA (US)

(21) Appl. No.: 16/558,373

(22) Filed: Sep. 3, 2019

Related U.S. Application Data
(60) Provisional application No. 62/727,257, filed on Sep. 5, 2018.

(51) Int. Cl. G10K 11/178; G10L 21/0232; H04R 1/40; H04R 3/12

(52) U.S. Cl. CPC G10K 11/17817; G10L 21/0232; G10L 2021/02082; H04R 1/403; H04R 3/12; G10K 11/17875

(57) ABSTRACT

Disclosed herein is an acoustic system including one or more acoustically transparent loudspeakers and one or more acoustic sensors. The system can utilize the acoustic transparency of acoustically transparent loudspeakers in order to avoid echo while cancelling, creating, and modifying waves. Furthermore, the system cancels and modifies a larger system or spatially complex wave-front, not just at a singular point. The system globally senses and globally cancels sound fields in both simple and complex environments.

### CROSS-REFERENCE

This application claims the benefit of U.S. Provisional Application No. 62/727,257, filed Sep. 5, 2018, which is incorporated herein by reference.

### BACKGROUND OF THE INVENTION

Unwanted noise can be problematic in environments that humans inhabit. Sources of noise generate unwanted sounds that can annoy, distract, or even fatigue a listener. This effect can prevent focus and comprehension of sound that carries useful or critical information. The unwanted sound can be quite complex in nature, consisting not only of sound radiation from a source, but also the complex pattern of the reverberation of the environment in which the sound was created. Some systems set out to cancel or correct this unwanted noise using active methods that consist of actuators (e.g. loudspeakers) and sensors (e.g. microphones). These systems are limited by the distortion of the original sound field due to actuator's presence and the feedback path, often referred to as echo, between the actuator and the sensor that the system introduces. These limitations restrict the effectiveness of such noise reduction systems to small, localized points in space. Due to the complex nature of the acoustic field, this localized cancellation can result in amplification or creation of additional noise at other spots in the acoustic environment.

An acoustically transparent loudspeaker-sensor system can solve the problem by reducing or eliminating both the effect of the loudspeaker on the original sound field and the acoustic feedback path between the loudspeakers and sensors. Disclosed herein are methods and systems that can both sense a complex wave field and reconstruct a modification or augmentation of that wave field. With integrated sensing and generation capabilities, the system here can cancel, control, create, and modify a complete wavefront, rather than the sound at a singular point. By including the shape and directional nature of the wave field in the cancellation system, noise can be canceled in a more global manner, without creating additional unwanted sound in regions outside of the cancellation zone. Furthermore, the system disclosed herein can greatly reduce or eliminate the echo or feedback problem often experienced with noise cancellation systems.

### SUMMARY OF THE INVENTION

A loudspeaker-sensor system, comprising: an acoustically transparent loudspeaker; a sensor; and a processing program connecting the loudspeaker(s) to the sensor(s). In some embodiments, the system is further comprised of the colocation of the sensor(s) and the loudspeaker(s). In some embodiments, the system is further comprised of a duct holding the loudspeaker(s) and the sensor(s). In some embodiments, the system is further comprised of a spherical array of loudspeakers and sensor(s). In some embodiments, the system is further comprised of a cylindrical array of loudspeakers and sensor(s). In some embodiments, the system is further comprised of utilizing the system for echo-free or echo-reduced noise cancellation. In some embodiments, the system is further comprised of global wave-front sensing. In some embodiments, the system is further comprised of spatial radiation control. In some embodiments, the system is further comprised of wave modification. In some embodiments, the system is further comprised of wave augmentation. In some embodiments, the system is further comprised of global wave-front cancellation. In some embodiments, the speaker-sensor system further includes a second acoustically transparent loudspeaker, wherein the second acoustically transparent loudspeaker is attached to the first acoustically transparent loudspeaker by an electrode.

A method of noise control, comprising: intaking acoustic waves through a sensor; processing intake data, wherein processing includes determining whether an echo or other possible flaws in an acoustical system exists; in response to determining a flaw exists, selecting a noise modification output, a cancelation output, or addition output to correct the wavefront; processing the output needed including magnitude, direction, and amplitude; and outputting correctional waves through an acoustically transparent loudspeaker. In some embodiments, the method includes outputting new acoustical waves paired with the correctional waves. In some embodiments, the method includes implementing a mathematical optimization algorithm for determining output needed. In some embodiments, the intaking of acoustic waves occurs after first outputting waves from the acoustically transparent loudspeaker.

A non-transitory computer-readable storage medium storing program instructions computer-executable to perform: intaking acoustic waves through a sensor located behind an acoustically transparent loudspeaker; processing intake data, wherein processing includes determining whether an echo or other possible flaws in an acoustical system exists; in response to determining a flaw exists, selecting a noise modification output, a cancelation output, or addition output to correct the wavefront; processing the output needed including magnitude, direction, and amplitude; and outputting correctional waves through the acoustically transparent loudspeaker. In some embodiments, the non-transitory computer-readable storage medium stored instructions includes outputting new acoustical waves paired with the correctional waves. In some embodiments, the non-transitory computer-readable storage medium stored instructions includes implementing a mathematical optimization algorithm for determining output needed. In some embodiments, the intaking of acoustic waves occurs after first outputting waves from the acoustically transparent loudspeaker.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention can be obtained by reference to the following detailed description that sets forth illustrative embodiments, in which the principles of the invention are utilized, and the accompanying drawings of which:

FIG. 1 is an exemplary illustration of a cylindrical embodiment of the sensor-loudspeaker system.

FIG. 2 is an exemplary illustration of an embodiment of the system through a duct.

FIG. 3 is an exemplary illustration of a spherical embodiment of the system.

FIG. 4 is an exemplary illustration of a cylindrical embodiment of the system including a sensing array located behind a loudspeaker array.

FIG. 5 is an exemplary illustration of a planar embodiment of the system.

FIG. 6 is an exemplary flowchart of the interpretation of waves to commands.

FIG. 7 is an exemplary illustration of a multi-layered cylindrical embodiment of the sensor-loudspeaker system.

FIG. 8 is an exemplary illustration of a multi-layered spherical embodiment of the sensor-loudspeaker system.

FIG. 9 is an exemplary illustration of the sensor-loudspeaker system utilized on a plane.

FIG. 10 is an exemplary illustration of the sensor-loudspeaker system in a workspace.

FIG. 11 is an exemplary illustration of an assembly of the loudspeaker array.

FIG. 12 is an exemplary flowchart of one embodiment of the method of noise control.

FIG. 13 is an exemplary illustration of one embodiment of the processing system for noise control.

### DETAILED DESCRIPTION OF THE INVENTION

The system in most embodiments includes one or more acoustically transparent loudspeakers integrated with one or more sensors in order to facilitate the creation, cancellation, modification, and overall control of sound. The system can be manipulated into various shapes including but not limited to a sphere, a cylinder, or a planar model. Due to the acoustic transparency of the loudspeakers, the location of the loudspeakers relative to the sensors can be variable. The introduction of non-acoustically transparent loudspeakers into the acoustic environment can alter the original sound field. This alteration of the sound field can limit and restrict the effectiveness of the system. The use of acoustically transparent loudspeakers can prevent such alterations of the sound field and can enable global sound reduction or modification.

The feedback path impediment can be reduced or eliminated in the acoustically transparent loudspeaker-sensor system. This feedback path is commonly known as echo. The sensors in the system can detect the sound from the original acoustic field as well as the sound from the system's loudspeakers. Other systems must use complicated signal processing to estimate and filter out the sound introduced to the sensor by this feedback path. Errors in this signal processing can lead to the system imperfectly cancelling and/or modifying the noise, and potentially adding additional unwanted noise to the environment. Arrays of acoustically transparent loudspeakers can reduce or eliminate the feedback impediment to the sensor intake.

Acoustic transparency of an object can occur when there is negligible alteration of the amplitude, phase, and direction of propagation of an incident sound field due to the presence of that object. The acoustic transparency of the loudspeakers can allow for the arrangement of multiple loudspeakers into a single array. This array can be comparable to or larger than an acoustic wavelength but can still allow a wave field to pass through it unaltered. The array can then be integrated with one or more sensors to sense the original wave field. The sensors can inform what corrective measures are needed to create, cancel, and/or adapt the sound field that is desired for the space.

The system can be capable of global wave-front sensing and/or global wave-front cancellation. An array of acoustically transparent loudspeakers, an array of sensors, spatial and temporal noise cancellation algorithms, and/or an echo cancellation feature can enable global wave-front cancellation. One embodiment for achieving acoustical transparency includes using thin-film thermoacoustic loudspeakers in the device (e.g. carbon nanotube films). In these embodiments, the films can enable sound generation while still exhibiting acoustical transparency.

In some embodiments, the system can decompose the incident wave-field into a set of components which describe its spatial variation. The sensors can decompose the incident wave-field by separating the waves into different channels in order to more accurately cancel and modify the waves, e.g., to get rid of harsh and/or annoying sounds. The decomposition can allow the system to instruct the loudspeakers more accurately in order to achieve improved cancellation and modification of the output sound.

The sensors used in the system may consist of microphones, accelerometers, particle velocity probes, or other similar acoustic sensors.

The processing algorithm in the system can analyze the sensed signals and can generate a set of corrective signals to be transmitted by each loudspeaker. The algorithm can generate the transmitted signals based upon the geometric arrangement of the sensors, loudspeakers, and the incident wavefield. In some embodiments, when an array of sensors is used, the geometric shape of sensors samples the wavefield at different locations in space. The processing algorithm can use these multiple sensors to sense both the acoustic signal and the wavefield's directional properties, based upon the geometric arrangement of the sensors in the array. Such properties can include the direction of arrival of multiple acoustic signals, reflections off of room surfaces, or environmental background noise. In some embodiments, the transmitted signals from the loudspeaker array are generated from the wavefield detected by the sensors. For example, the transmitted signals may be the opposite phase of the incident wavefield in order to cancel the incident waves. In this case, the algorithm may compute a series of time delays, amplitude weights, or filters to form multiple acoustic beams from the loudspeaker array that cancel the shape of the incident wavefront sensed by the sensor array.

In some embodiments, the processing algorithm calculates amplitude and phase gradients to be applied to the signals transmitted by each loudspeaker in order to minimize the difference between the sensed acoustic wavefield and the wavefield that will be transmitted. The sensor array can be fed into the processing algorithm that can generate cancellation signals for the loudspeaker array, in terms of phase and amplitude. In some embodiments, the minimization will be accomplished using a Least-Mean-Squares optimization algorithm. Other embodiments may include maximum likelihood estimation or other similar optimization algorithms.

In some embodiments, the signals are calculated to cancel only portions of the incident wavefield, such as high frequency sounds that may be perceived to be most annoying or specific sound sources arriving only from specific directions. In some embodiments, the signals transmitted by each loudspeaker are derived from the sensed wavefield. The processing algorithm can calculate the transmitted waveforms to minimize the difference between the sensed and the transmitted wavefields, weighted by a predefined algorithm. In some embodiments, the algorithm may measure and weight the difference between the wavefields by frequency band. In some embodiments, the algorithm may measure and weight the difference between the wavefields to cancel frequencies in the sensed waveforms with harmonic relationships.

In some embodiments, the transmitted signals are not derived from the incident wavefield but calculated to augment the incident signals, such as masking annoying sounds with more pleasing sounds or generating new sounds focused in specific directions.

The system can be utilized as an acoustic tracking and mapping system. The system can create acoustic waves and can later receive acoustic waves, recording the time between transmission and reception and the direction of arrival of acoustic waves, along with any changes to the transmitted wave. The information gathered can be used to map a room by determining distances and directions to objects, boundaries, and edges in the room, along with acoustic properties of those boundaries. The mapped room data can be further utilized to refine the modified sound field.

In some embodiments, the system includes the loudspeakers and sensors being collocated. In some embodiments, the sensor array is concentric to the acoustically transparent loudspeaker array (i.e. a cylinder or sphere). In some embodiments, the sensor array is located in a different area than the acoustically transparent loudspeaker array.

In some embodiments, the acoustically transparent loudspeaker array will be connected by electrodes and mounted on insulated materials.

In some embodiments, the system will include one layer of acoustically transparent loudspeakers. In other embodiments, the system can include multiple layers of acoustically transparent loudspeakers.

In some embodiments, acoustically transparent refers to the impediment of waves being negligible. In these embodiments, the impediment is negligible when loss of wave amplitude is less than twelve percent of the wave amplitude. The acoustical transparency can occur when the largest dimension of individual elements of the structure are less than the wavelength of the acoustic wave.

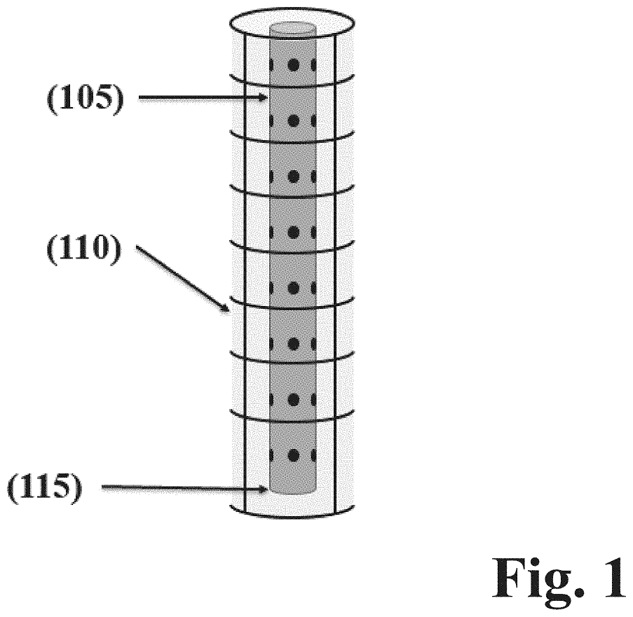

The cylindrical embodiment in FIG. 1 displays the arrangement of the system. The sensors (105) are mounted on a central fixture (115). The sensors (105) take in the noise relaying the information to the corrective programming, which can trigger the creation of waves through the acoustically transparent loudspeakers (110). Once the new waves are created, those waves and other waves being detected by the sensors (105) can be unimpeded as the waves pass through the acoustically transparent loudspeakers (110).

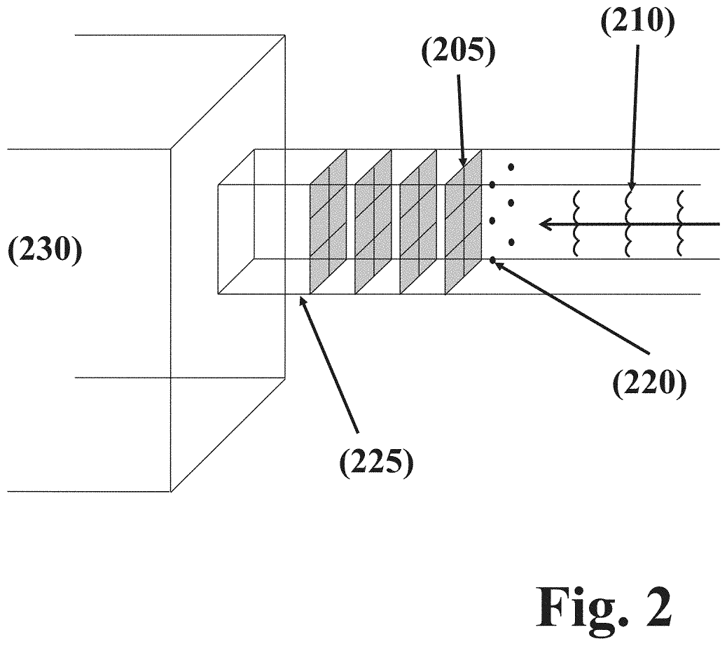

The duct system embodiment in FIG. 2 conveys the possible configuration of the system to create the cancellation/modification achieved through the sensor-loudspeaker system. The system being controlled (230) is supplied waves through a system duct (225). The duct contains one or more acoustically transparent loudspeakers (205) and sensors (220). The sensors (220) detect acoustic waves (210), transmit the information, and the programming instructs the acoustically transparent loudspeakers to produce cancelling or modifying waves. Improved cancellation is obtained due to the acoustic transparency of the loudspeakers allowing for the echo or feedback effect to be greatly reduced. The sensors can be collocated with the loudspeakers or could be placed at a location along the direction of sound propagation in the duct.

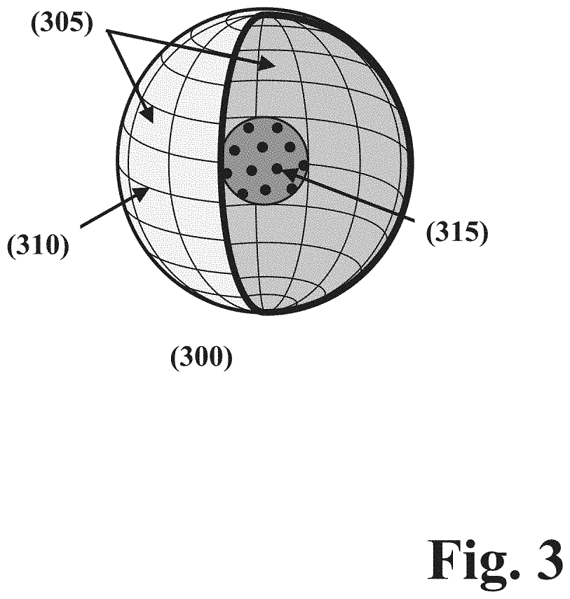

The spherical embodiment depicted in FIG. 3 of the sensor-speaker system shows both the sensor array and the loudspeaker array as three-dimensional spherical shapes. The system (300) includes at least one spherical array of thin film loudspeaker elements (305). Inside the elemental sphere (305) is a smaller sphere fixture that can house the sensor array (315). The thin film loudspeaker array (305) is acoustically transparent and is intertwined by an electrode structure (310). The figure depicts the sensors behind acoustically transparent loudspeakers, which can limit echo in the cancellation process by applying amplitude and time delay gradients to each sphere of loudspeakers in order to cancel the waves propagating backwards towards the sensors. The spherical shape can be a preferred embodiment for receiving and conveying acoustic waves.

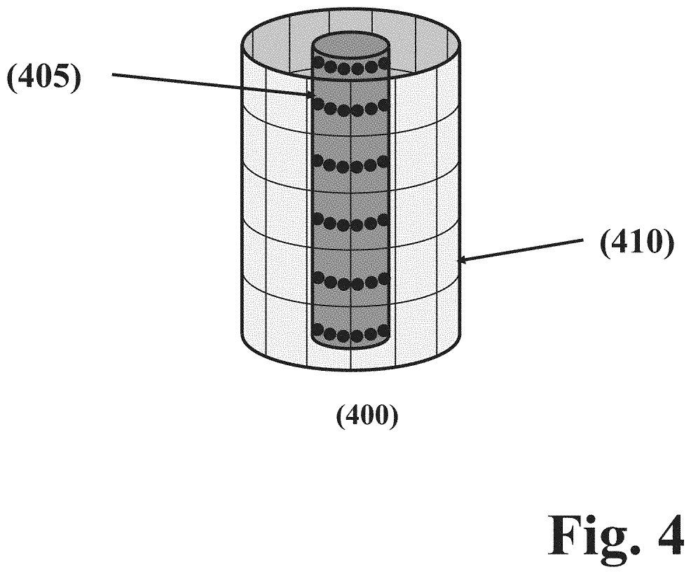

The cylindrical embodiment depicted in FIG. 4 displays the possible assembly of the sensor-speaker system in a three-dimensional cylindrical shape. The system (400) includes an array of sensors (405) being surrounded by an array of acoustically transparent loudspeakers (410). Both the sensors (405) and the loudspeakers (410) are in a three-dimensional cylindrical shape oriented such that the walls of each cylinder are parallel. The sensors (405) are attached to a fixture, and the loudspeakers (410) are part of an electrode structure. The cylindrical shape can give the loudspeakers and the sensors concentric transmitting and receiving acoustic centers that are equidistant from any boundaries or obstacles in the surrounding environment.

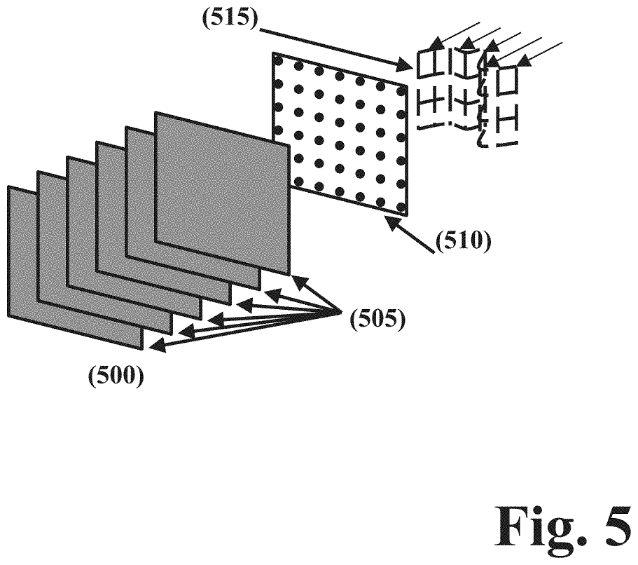

The planar embodiment shown in FIG. 5 depicts a two-dimensional perspective. The system (500) includes an array of sensors (510) and an array of loudspeakers (505). The system (500) receives a complex incident wave-field (515). The wave-field (515) first meets the sensor array (510). The sensor array (510) receives the waves, translates them into information for the program, the program takes the information, and the program conveys orders to the array of acoustically transparent loudspeakers (505). When the wave-field (515) passes through the array of loudspeakers, the waves (515) propagate unimpeded through the loudspeakers (505), but the waves (515) are accompanied by additional cancelling or modifying waves created by the loudspeakers (505), as ordered by the program. The techniques can be used to generate and process the sensed wavefield, commonly referred to as beamforming, and can be based upon the geometry and number of sensors in the array.

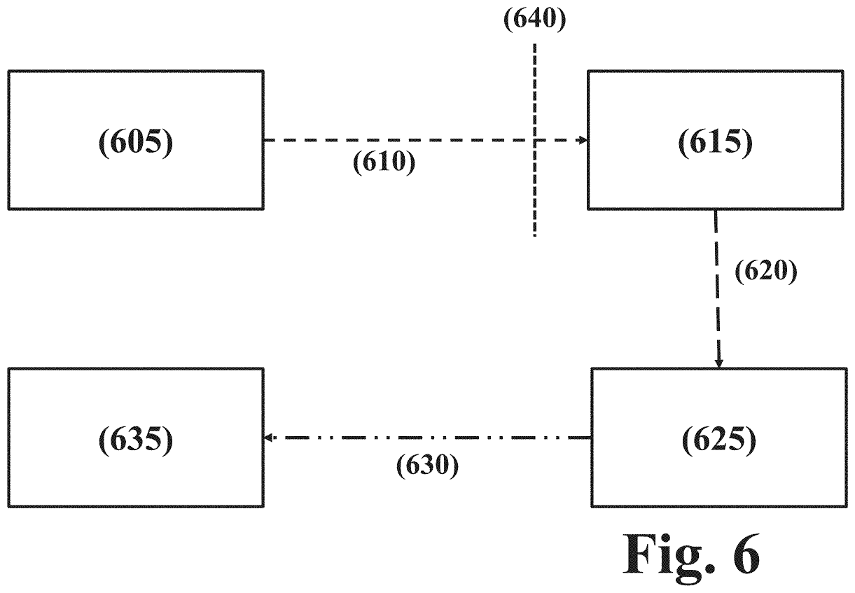

FIG. 6 depicts an embodiment of the incident wave-field relation to commands given to the acoustically transparent loudspeakers. In this embodiment, some source or sources of outside acoustical waves (605) creates an incident wave-field (610). In this embodiment, the incident wave-field (610) passes through the acoustically transparent loudspeaker (640), unaltered due to the acoustic transparency, and reaches the sensor array (615). The sensor array (615) passes data (620) about the incident wave-field (610) onto the processing program (625). In some embodiments, the processing program consists of analog or digital circuitry to filter and condition the signals from the sensor array, a computing program to interpret the received signals and generate corrective signals, and analog or digital circuitry to condition or amplify the corrective signals transmitted to the acoustically transparent loudspeaker. The computing program may be executed on a microcontroller, digital signal processor (DSP), field programmable gate array (FPGA), or other application specific integrated circuit (ASIC). In this embodiment, the computing program (625) interprets the data, formulates corrective actions for the wave-field, and sends a command (630) to the acoustically transparent loudspeaker (635) to perform the corrective actions.

The computing program can process the data from multiple sensors using beamforming techniques which analyze the directional characteristics of an incident wavefront. Beamforming can consist of summing the response from multiple sensors after applying time delays, amplitude weights, and can filter to sense a wavefront in different spatial directions. The specifics of the beamforming processing can be performed by the processing program depending upon the geometry of the sensors, which may include spherical, cylindrical, planar, linear, or other arrangements. In some embodiments, once the wavefield is represented by different spatial components, these components are fed into the processing algorithm, which then generates signals for the loudspeaker array. In some embodiments, the array of acoustically transparent loudspeakers also utilizes beamforming to transmit the cancellation signals into the same spatial directions from which they were sensed. In some embodiments, time delays, amplitude weights, and filters are used to transmit each cancellation signal into the direction it was sensed in the wavefield. This loudspeaker array can also simultaneously generate cancellation signals and other sounds. In some embodiments, these sounds will include directionally controlled masking sounds used the same beamforming techniques, to mask any unwanted sounds that are not actively cancelled. In some embodiments, these additional sounds will include speech, music, or other informational sound content.

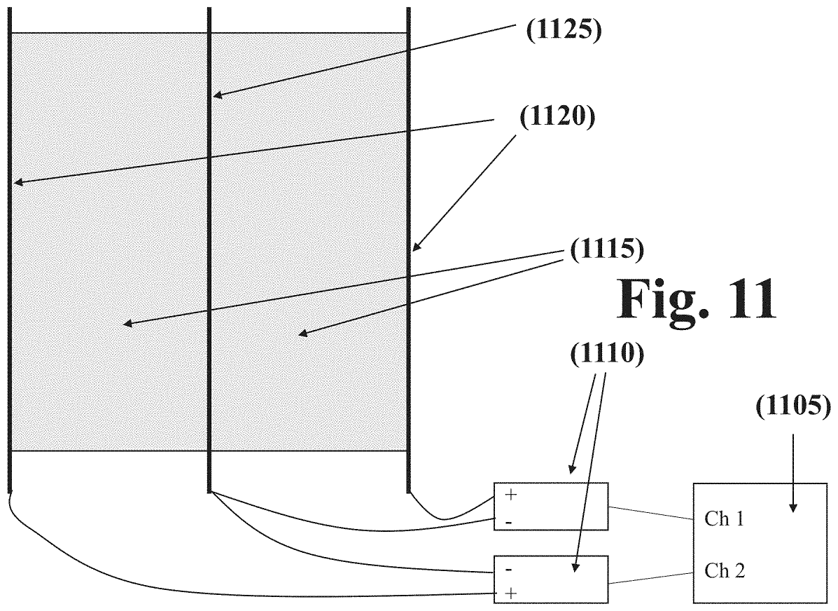

FIG. 11 depicts a singular embodiment of the electrical connections of a loudspeaker array consisting of two acoustically transparent loudspeakers. A digital signal processing unit (DSP) (1105) generates the corrective signals that are transmitted to a separate amplifier (1110) for each loudspeaker. The signals output from the DSP may be analog or digital. The algorithm on the DSP will determine the nature of each signal in order to achieve the desired sound cancellation, modification, or augmentation. The generated signals may have different amplitudes, time delays, or phases for each loudspeaker in the array. The acoustically transparent loudspeakers (1115) consist of carbon nanotube films fixed between electrodes. Each carbon nanotube film is attached to two electrodes that provide structural integrity to the array and electrical connection to the films. The material of the electrodes may be metal, conductive resin, or other suitable electrically conducting material. The shape of the electrodes may be a rod, wire, or other structure that provides suitable electrical connections and structural support to the stretched films. Non-conducting structural supports hold the electrodes. Each amplifier is wired to a unique positive electrode (1120) and a common negative electrode (1125) that is in electrical contact with each loudspeaker. The carbon nanotube films are attached to the electrodes by their natural adhesive properties or by a conductive epoxy or other similar adhesive. In other embodiments, each loudspeaker and amplifier may be connected to unique positive and negative electrodes.

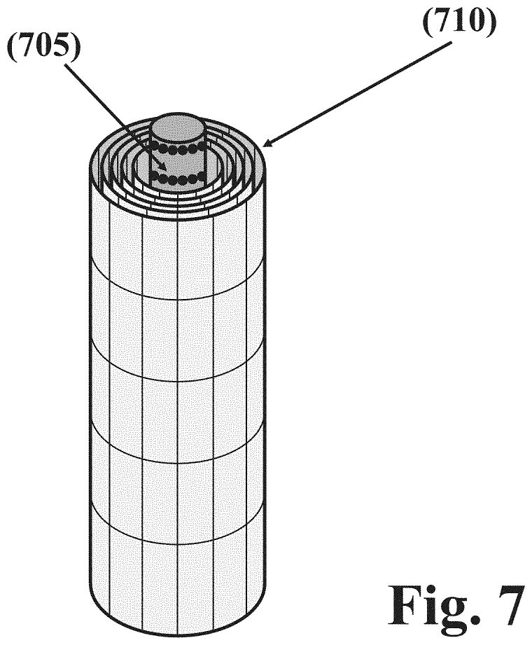

FIG. 7 depicts a cylindrical embodiment consisting of a cylindrical array of sensors (705) and a cylindrical array of acoustically transparent loudspeakers (710). The loudspeakers (710) are arranged in multiple concentric cylindrical layers. The acoustical transparency of the loudspeakers can allow for the use of multiple layers without impacting or distorting the incident sound field before it is sensed by the sensor array. Multiple layers of loudspeakers, with time delays applied to their transmitted signals to form an end-fire array configuration, can be used to increase the transmitted power and to reduce or eliminate the feedback path from the loudspeakers to the sensor array.

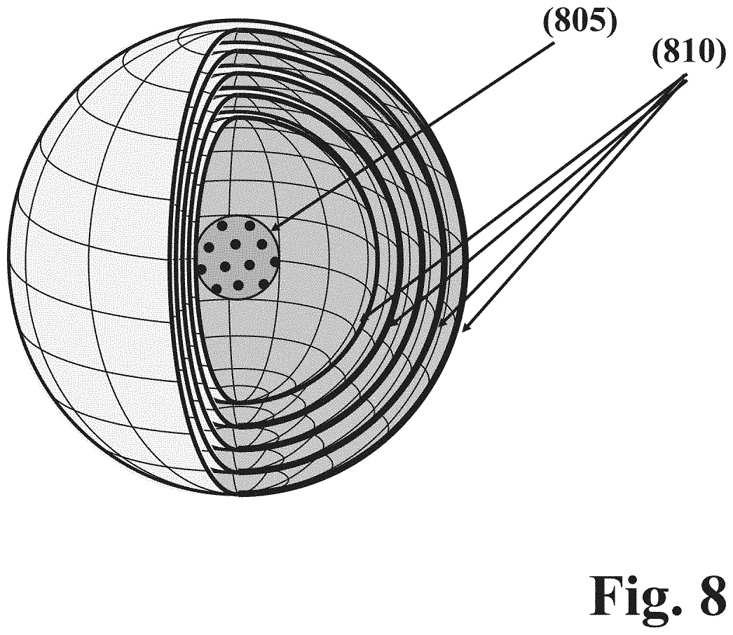

FIG. 8 depicts a spherical embodiment consisting of a spherical array of sensors (805) and a spherical array of acoustically transparent loudspeakers (810) arranged in concentric layers. The interior sensor array (805) can detect and decompose the incident sound field into a set of spatial components. The loudspeaker array (810) can then transmit signals to globally cancel the incident field in the space outside of the system. The signals generated at each element of the loudspeaker array (810) can also combine to reduce or eliminate the feedback path back to the sensor array at the interior of the system.

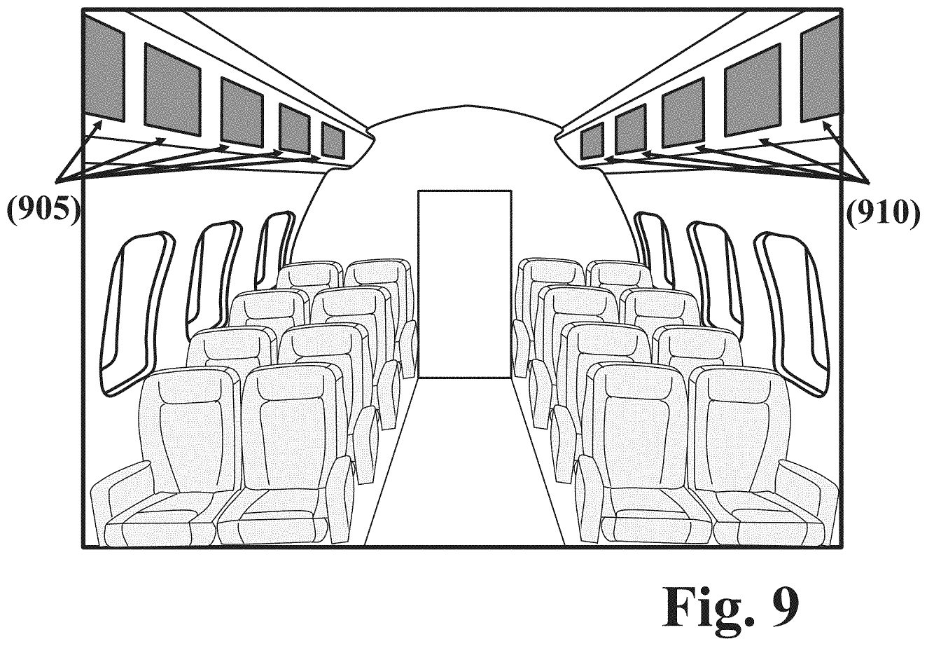

FIG. 9 depicts the application of the system to an aircraft cabin. A series of acoustically transparent loudspeaker panels (905) can be embedded into the interior walls of the cabin. A sensor array (910) can be located behind each panel. The processing system (not shown) can compute cancellation signals for the loudspeaker based on the signals measured by the sensors. Noise generated outside of the cabin or reflecting off of the cabin walls can be detected by the sensor array (910) and can be cancelled as it passes through the loudspeaker panels (905). This can achieve an overall noise reduction inside the cabin.

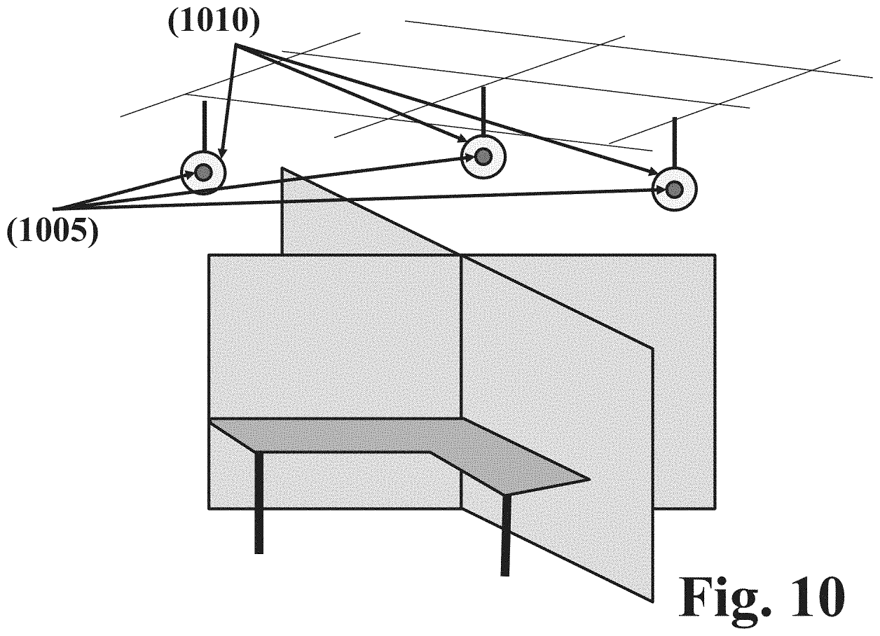

FIG. 10 depicts the application of the system to an office environment. Concentric spherical arrays of acoustically transparent loudspeakers (1010) and sensors (1005) can be hung from the ceiling. The complex acoustic noise field and room reflections incident upon each array can be sensed by each array and can be decomposed into three dimensional spatial components. The processing algorithm (not shown) can generate signals that are transmitted by the loudspeaker array to modify the spatial sound field in the office in a manner that reduces noise or makes it more pleasant for the occupants.

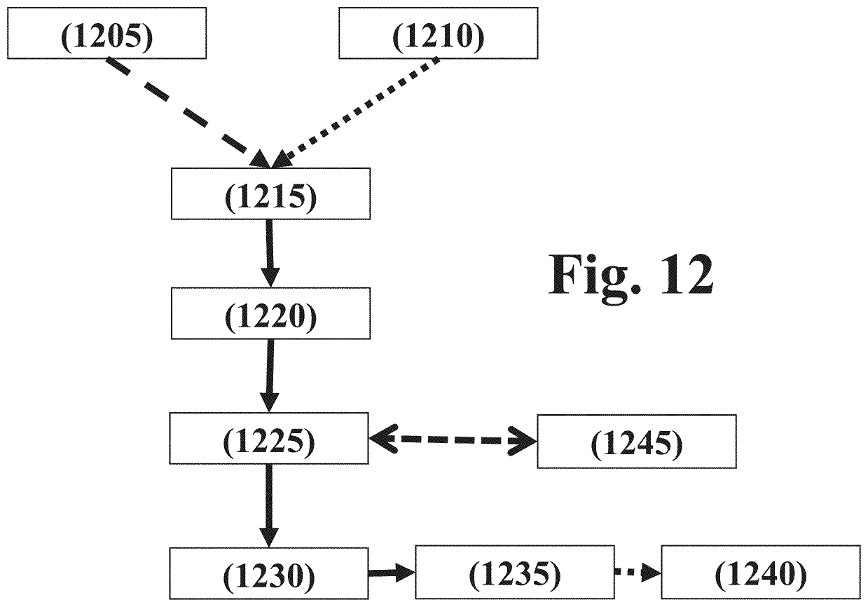

FIG. 12 depicts one embodiment of the method of noise control. In some embodiments, either the acoustically transparent loudspeakers emit soundwaves (1205) or some other device emits soundwaves (1210). In some embodiments, the sensors then intake the acoustic waves (1215). In some embodiments, a processor processes the intake data (1220), wherein processing includes determining whether an echo or other possible flaws in an acoustical system exists. In some embodiments, in response to determining a flaw exists, a selection is made between a noise modification output, a cancelation output, or addition output to correct the wavefront (1225). In some embodiments, the output needed is processed (1230) including the magnitude, the direction, and the amplitude. In some embodiments, the last step is outputting correctional waves through an acoustically transparent loudspeaker (1235). In some embodiments, the method includes outputting new acoustical waves paired with the correctional waves (1240). In some embodiments, the method includes implementing a Least-Mean-Squares optimization algorithm for determining output needed (1245).

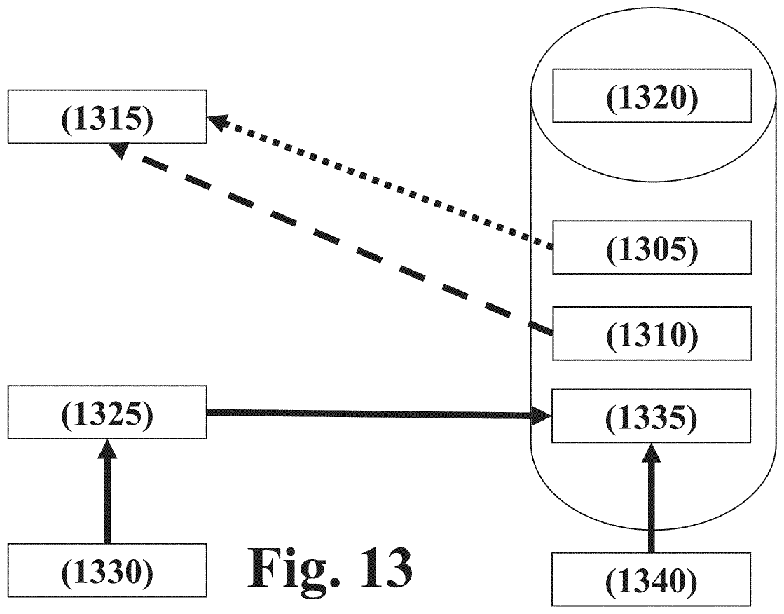

FIG. 13 depicts the system environment of one embodiment of the processing system. In some embodiments, the module (1320) includes storage media, system memory, new noise creator (1305), modification/addition/cancellation noise creator (1310), a processor (1335), and a database of algorithms. In some embodiments, the sensor (1325) intakes acoustic waves from the environment (1330), then relays the data to the processor (1335). In some embodiments, the processor receives data from other sources (1340) as well to know the intended purpose. The other sources may be manual input or a variety of other sources. In some embodiments, the processor analyzes the data and determines if a corrective action is needed. In some embodiments, if corrective action is needed, the modification/addition/cancellation noise creator (1310) sends information to the acoustically transparent loudspeaker. The module may also send instructions from the new noise creator (1305) to the acoustically transparent loudspeaker (1315) to emit acoustic waves that are not corrective in nature.

In some embodiments, the embodiment further includes sending, receiving, or storing data, instructions, or both upon a computer-readable medium. Methods disclosed above may be accomplished by one computer or may be accomplished through a plurality of computers, and the method should not be construed as one or the other. The methods may be implemented in hardware, software, or an amalgamation of both. The systems, methods, and procedures disclosed herein can be embodied in a programmable computer, computer-executable software, or digital circuitry. The software can be stored on computer-readable media. Some examples of computer-readable media can include a RAM, ROM, floppy disk, hard disk, flash memory, memory stick, removable media, optical media, magneto-optical media, CD-ROM, or any other viable form. Digital circuitry can include, but not limited to, integrated circuits, building block logic, gate arrays, field programmable gate arrays, or any other viable form. In some embodiments, the method may be reordered, changed, additional steps added, steps removed, steps combined, and otherwise modified. In some embodiments, the steps are automated. Chronological wording such as first, second, third, and so forth should not be viewed as limiting, but instead as one possible embodiment.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A speaker-sensor system, comprising:
an acoustically transparent loudspeaker;
a sensor; and
a processing program connecting the loudspeaker to the sensor.

2. A speaker-sensor system as set forth in claim 1, further comprising:
colocation of the sensor and the loudspeaker.

3. A speaker-sensor system as set forth in claim 1, further comprising:
a duct holding the loudspeaker and the sensor.

4. A speaker-sensor system as set forth in claim 1, further comprising:
a spherical array of loudspeakers and sensor

5. A speaker-sensor system as set forth in claim 1, further comprising:
a cylindrical array of loudspeakers and sensor.

6. A speaker-sensor system as set forth in claim 1, further comprising:
utilizing the system for echo-free or echo-reduced noise cancellation.

7. A speaker-sensor system as set forth in claim 1, further comprising:
global wave-front sensing.

8. A speaker-sensor system as set forth in claim 1, further comprising:
spatial radiation control.

9. A speaker-sensor system as set forth in claim 1, further comprising:
wave modification.

10. A speaker-sensor system as set forth in claim 1, further comprising:
wave augmentation.

11. A speaker-sensor system as set forth in claim 1, further comprising:
global wave-front cancellation.

12. A speaker-sensor system as set forth in claim 1, further comprising a second acoustically transparent loudspeaker, wherein the second acoustically transparent loudspeaker is attached to the first acoustically transparent loudspeaker by an electrode.

13. A method of noise control, comprising:
intaking acoustic waves through a sensor;
processing intake data, wherein processing includes determining whether an echo or other possible flaws in an acoustical system exists;
in response to determining a flaw exists, selecting a noise modification output, a cancelation output, or addition output to correct the wavefront;
processing the output needed including magnitude, direction, and amplitude; and
outputting correctional waves through an acoustically transparent loudspeaker.

14. A method as in claim 13, further comprising: outputting new acoustical waves paired with the correctional waves.

15. A method as in claim 13, further comprising:
implementing a mathematical optimization algorithm for determining output needed.

16. A method as in claim 13, wherein intaking acoustic waves occurs after first outputting waves from the acoustically transparent loudspeaker.

17. A non-transitory computer-readable storage medium storing program instructions computer-executable to perform:
intaking acoustic waves through a sensor located behind an acoustically transparent loudspeaker;
processing intake data, wherein processing includes determining whether an echo or other possible flaws in an acoustical system exists;
in response to determining a flaw exists, selecting a noise modification output, a cancelation output, or addition output to correct the wavefront;
processing the output needed including magnitude, direction, and amplitude; and
outputting correctional waves through the acoustically transparent loudspeaker.

18. A method as in claim 17, further comprising: outputting new acoustical waves paired with the correctional waves.

19. A method as in claim 17, further comprising:
implementing a mathematical optimization algorithm for determining output needed.

20. A method as in claim 17, wherein intaking acoustic waves occurs after first outputting waves from the acoustically transparent loudspeaker.
